(19) United States
(12) Patent Application Publication
(10) Pub. No.: US 2013/0106709 A1
(43) Pub. Date: May 2, 2013

(54) Touch Sensor With User Identification

(71) Applicant: Martin John Simmons, Southhampton (GB)

(72) Inventor: Martin John Simmons, Southhampton (GB)

(21) Appl. No.: 13/284,115

(22) Filed: Oct. 28, 2011

(51) Int. Cl. G06F 3/041

(52) U.S. Cl. 345/173

(57) ABSTRACT

In one embodiment, a method includes determining, by a touch sensor coupled to a display, whether a particular user is using an input device to interact with the interactive display and receiving, at a controller, an identification signal transmitted by the input device. The identification signal indicates an identifier stored in the input device. The method further includes accessing, by the controller, a plurality of profiles stored in one or more memory devices accessible to the controller, and identifying, by the controller using the received identification signal, a particular profile of the particular user. Each of the profiles are associated with one of a plurality of users. The method further includes displaying, by the controller in response to the touch sensor determining that the user is using the input device to interact with the interactive display, content on the display according to the particular profile of the particular user.

### TECHNICAL FIELD

This disclosure generally relates to touch sensors.

### BACKGROUND

A touch sensor may detect the presence and location of a touch or the proximity of an object (such as a user's finger or a stylus) within a touch-sensitive area of the touch sensor overlaid, for example, on a display screen. In a touch-sensitive-display application, the touch sensor may enable a user to interact directly with what is displayed on the screen, rather than indirectly with a mouse or touchpad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are different types of touch sensors, such as (for example) resistive touch screens, surface acoustic wave touch screens, capacitive touch screens, infrared touch screens, and optical touch screens. Herein, reference to a touch sensor may encompass a touch screen, and vice versa, where appropriate. A capacitive touch screen may include an insulator coated with a substantially transparent conductor in a particular pattern. When an object touches or comes within proximity of the surface of the capacitive touch screen, a change in capacitance may occur within the touch screen at the location of the touch or proximity. A controller may process the change in capacitance to determine the touch position(s) on the touch screen.

### BRIEF DESCRIPTION OF THE DRAWINGS

FIG. 1 illustrates an example device with a touch-sensitive area, according to certain embodiments;

FIG. 2 illustrates an example device that may utilize the touch sensor of FIG. 1, according to certain embodiments;

FIG. 3 illustrates an example touchscreen display the device of FIG. 2, according to certain embodiments;

FIGS. 4A and 4B illustrate particular embodiments of a stylus that may be utilized to interact with the device of FIG. 2, according to certain embodiments;

FIG. 5 illustrates personalized content that may be displayed on the device of FIG. 2, according to certain embodiments; and

FIG. 6 illustrates a method for displaying content on a display according to an identification of a user.

### DESCRIPTION. OF EXAMPLE EMBODIMENTS

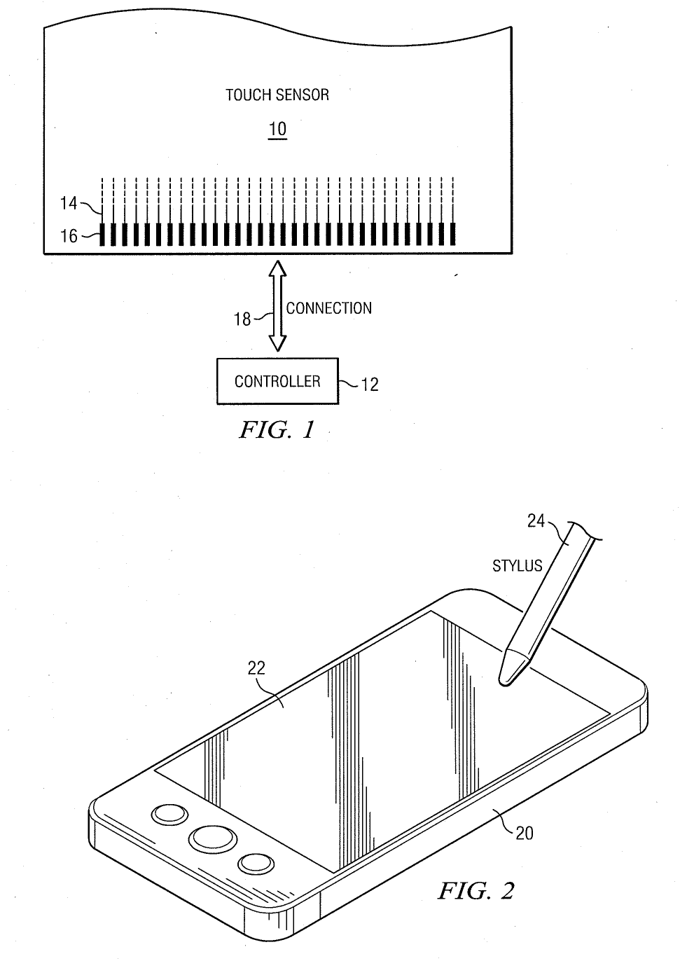

FIG. 1 illustrates an example touch sensor 10 with an example controller 12. Herein, reference to a touch sensor may encompass a touch screen, and vice versa, where appropriate. Touch sensor 10 and controller 12 may detect the presence and location of a touch or the proximity of an object within a touch-sensitive area of touch sensor 10. Herein, reference to a touch sensor may encompass both the touch sensor and its controller, where appropriate. Similarly, reference to a controller may encompass both the controller and its touch sensor, where appropriate. Touch sensor 10 may include one or more touch-sensitive areas, where appropriate. Touch sensor 10 may include an array of drive and sense electrodes disposed on a substrate, which may be a dielectric material.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made indium tin oxide (ITO) in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a gap between them. A pulsed or alternating voltage applied to the drive electrode (by controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and controller 12 may measure the change in capacitance. By measuring changes in capacitance throughout the array, controller 12 may determine the position of the touch or proximity within the touch-sensitive area(s) of touch sensor 10.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have a single-layer configuration, with drive and sense electrodes disposed in a pattern on one side of a substrate. In such a configuration, a pair of drive and sense electrodes capacitively coupled to each other across a space between them may form a capacitive node. In a single-layer configuration for a self-capacitance implementation, electrodes of only a single type (e.g. drive) may be disposed in a pattern on one side of the substrate. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Controller 12 may detect and process the change in capacitance to determine the presence and location of the touch or proximity input. Controller 12 may then communicate information about the touch or proximity input to one or more other components (such one or more central processing units (CPUs) or digital signal processors (DSPs)) of a device that includes touch sensor 10 and controller 12, which may respond to the touch or proximity input by initiating a function of the device (or an application running on the device) associated with it. Although this disclosure describes a particular controller having particular functionality with respect to a particular device and a particular touch sensor, this disclosure contemplates any suitable controller having any suitable functionality with respect to any suitable device and any suitable touch sensor.

Controller 12 may be one or more integrated circuits (ICs)—such as for example general-purpose microprocessors, microcontrollers, programmable logic devices or arrays, application-specific ICs (ASICs) and may be on a flexible printed circuit (FPC) bonded to the substrate of touch sensor 10, as described below. Controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular controller having a particular implementation with particular components, this disclosure contemplates any suitable controller having any suitable implementation with any suitable components.

Tracks 14 of conductive material disposed on the substrate of touch sensor 10 may couple the drive or sense electrodes of touch sensor 10 to bond pads 16, also disposed on the substrate of touch sensor 10. As described below, bond pads 16 facilitate coupling of tracks 14 to controller 12. Tracks 14 may extend into or around (e.g. at the edges of) the touch-sensitive area(s) of touch sensor 10. Particular tracks 14 may provide drive connections for coupling controller 12 to drive electrodes of touch sensor 10, through which the drive unit of controller 12 may supply drive signals to the drive electrodes. Other tracks 14 may provide sense connections for coupling controller 12 to sense electrodes of touch sensor 10, through which the sense unit of controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (similar to a bond pad 16) at an edge of the substrate of touch sensor 10 (similar to tracks 14).

Bond pads 16 may be located along one or more edges of the substrate, outside the touch-sensitive area(s) of touch sensor 10. As described above, controller 12 may be on an FPC. Bond pads 16 may be made of the same material as tracks 14 and may be bonded to the FPC using an anisotropic conductive film (ACF). Connection 18 may include conductive lines on the FPC coupling controller 12 to bond pads 16, in turn coupling controller 12 to tracks 14 and to the drive or sense electrodes of touch sensor 10. This disclosure contemplates any suitable connection 18 between controller 12 and touch sensor 10.

FIG. 2 illustrates an example device 20 that may utilize touch sensor 10 of FIG. 1. Device 20 may be any personal digital assistant, cellular telephone, smartphone, tablet computer, and the like. In certain embodiments, device 20 may include other applications such as automatic teller machines (ATM machines), home appliances, personal computers, and any other such device having touchscreen. For example, device 20 may be a smartphone that includes a touchscreen display 22 that occupies a significant portion of the largest surface of the device. In certain embodiments, the large size of touchscreen display 22 enables the touchscreen display 22 to present a wide variety of data, including a keyboard, a numeric keypad, program or application icons, and various other interfaces as desired. In certain embodiments, a user may interact with device 20 by touching touchscreen display 22 with a stylus 24, or any other appropriate object such as a finger, in order to interact with device 20 (i.e., select a program for execution or to type a letter on a keyboard displayed on the touchscreen display 22). In certain embodiments, a user may interact with device 20 using multiple touches to perform various operations, such as to zoom in or zoom out when viewing a document or image. In some embodiments, such as home appliances, touchscreen display 22 may not change or may change only slightly during device operation, and may recognize only single touches.

In general, embodiments of the disclosure utilize objects such as stylus 24 to identify a user and/or personalize content displayed on touchscreen display 22 according to the data stored in the object. In some embodiments, a password or personal data of a particular user is stored in stylus 24 and is transmitted to device 20 where it is utilized to personalize content displayed on device 20. In certain embodiments, as described in more detail below, an object such as stylus 24 stores an identification of a user and transmits the identification to device 20. For example, stylus 24 may transmit an identification signal to device 20 when it comes within proximity to device 20, when it touches touchscreen display 22, and/or when a user commands stylus 24 to transmit the identification signal. In certain embodiments, device 20 receives the identification, accesses one or more stored user profiles, and identifies one of the user profiles using the received identification. In some embodiments, device 20 customizes content displayed on touchscreen display 22 according to the identified user profile. For example, certain embodiments of device 20 may allows access to certain access levels and/or applications, change a visual characteristic of a graphical user interface (GUI), and/or provide access to specific data based on the identified profile. As a result, content displayed on display 36 may be personalized for each individual user simply by the user using an object such as stylus 24 to interact with device 20.

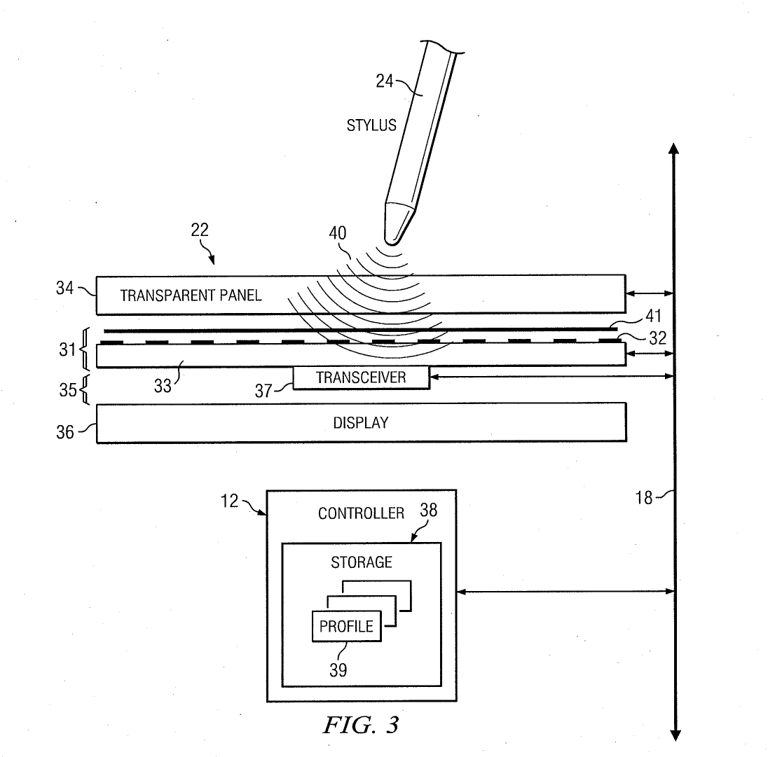

FIG. 3 illustrates an example touchscreen display 22 of device 20 of FIG. 2. In certain embodiments, touchscreen display 22 includes an assembly 31, a transparent panel 34, a display 36, a transceiver 37, and controller 12. Assembly 31, transparent panel 34, and transceiver 37 may be communicatively coupled to controller 12 via connection 18. Assembly 31 is disposed on an underside of transparent panel 34 and overlays display 36. In certain embodiments, an air gap 35 is located between assembly 31 and display 36. In some embodiments, an adhesive layer may be inserted in air gap 35 in order to laminate assembly 31 to the top of display 36.

Touchscreen display 22 is generally operable to detect when an object such as stylus 24 touches an active area of touchscreen display 22, or when an object comes within proximity to an active area of touchscreen display 22 (e.g., when an object is close enough to touchscreen display 22 to cause a detectable change in capacitance across electrodes 32 but does not physically contact transparent panel 34.) In some situations, it may be desirable to determine an identity of a user who is interacting with device 20 either when an object such as stylus 24 touches transparent panel 34 or when an object comes within proximity to touchscreen display 22. For example, in situations where stylus 24 is being utilized to write on a touchscreen display 22, it may be desirable to identify the user utilizing stylus 24 in order to personalize content displayed on display 36. Certain embodiments of the disclosure determine whether stylus 24 has contacted or has come within proximity to touchscreen display 22, receive an identification signal 40 transmitted by stylus 24, access a plurality of profiles stored in one or more memory devices accessible to controller 12, identify a particular profile 39 associate with a particular user interacting with device 20, and display content on display 36 according to the particular profile of the particular user.

In certain embodiments, assembly 31 includes one or more electrodes 32, a substrate 33, and an adhesive layer 41. Electrodes 32, which may include sense electrodes and/or drive electrodes, are printed or otherwise fashioned onto substrate 32. In certain embodiments, substrate 33 is a clear plastic sheet such as PET or polycarbonate, or potentially a glass layer. Adhesive layer 41 is used to bond assembly 31 to transparent panel 34. In certain embodiments, adhesive layer 41 is a liquid adhesive, an adhesive sheet, and the like. Assembly 31 may be manufactured via a laminating process to provide for an airtight assembly. Assembly 31, together with controller 12, may comprise one embodiment of touch sensor 10 described above.

In certain embodiments, electrodes 32 may be configured in a manner substantially similar to the drive and sense electrodes, respectively, described above with reference to FIG. 1. In certain embodiments, electrodes 32 may be fashioned from clear ITO, fine line metal traces, or other low visibility conductive material. In certain embodiments, assembly 31 and controller 12 may determine the location of objects such as stylus 24 at least in part by using controller 12 to apply a pulsed or alternating voltage to certain electrodes 32 (e.g., drive electrodes), which may induce a charge on certain other electrodes 32 (e.g., sense electrodes). When stylus 24 or any other object (i.e., a finger) touches or comes within proximity of an active area of touchscreen display 22, a change in capacitance may occur. The change in capacitance may be sensed by electrodes 32 and measured by controller 12. By measuring changes in capacitance throughout an array of electrodes 32, controller 12 may determine the position of the touch or proximity within the touch-sensitive area(s) of touchscreen display 22. In addition, as described further below, controller 12 may determine the identity of a user who is utilizing stylus 24 and personalize content displayed on touchscreen display 22 according to the user who is utilizing stylus 24.

In some embodiments, substrate 33 includes a single layer of electrodes 32. In other embodiments, touchscreen display 22 may include any appropriate configuration and number of layers of electrodes and substrates. For example, some embodiments of touchscreen display 22 may include additional layers of electrodes 32 that may run perpendicular (or any other appropriate angle) to electrodes 32 illustrated in FIG. 3. In such embodiments, substrate 33 may be sandwiched between layers of electrodes 32 (i.e., a layer of sense electrodes 32 may be coupled to one side of substrate 33 while a layer of drive electrodes are coupled to the opposite side of substrate 33).

Transparent panel 34 may be any appropriate layer of material on which a user may interact with device 20 using an object such as stylus 24 or a finger. In certain embodiments, transparent panel 34 is made of resilient, transparent material suitable for repeated touching by objects. Example of materials that may be used for transparent panel 34 may include glass, Polycarbonate, PMMA (poly(methyl methacrylate)), and the like.

Display 36 may be any appropriate device for displaying content to a user of device 20. In certain embodiments, display 36 may any appropriate active or passive display such as a liquid crystal display (LCD), a light-emitting diode displays (LED), an organic light-emitting diode (OLED), or any other existing or future display technology. Display 36 displays content to the user including any appropriate application running on any appropriate operating system. Controller 12 personalizes what is displayed on display 36 using an identification 48 stored in an object such as stylus 24, as described in more detail below.

Transceiver 37 is any appropriate device for communicating wirelessly with an object such as stylus 24. Transceiver 37 is communicatively coupled to controller 12 (either directly or indirectly through one or more other devices not illustrated). In certain embodiments, transceiver 37 is mechanically coupled to assembly 31 as illustrated. In other embodiments, transceiver 37 may be located in any appropriate location in device 20. Transceiver 37 may utilize any appropriate technology for wirelessly communicating with an object such as stylus 24. In certain embodiments, for example, transceiver 37 utilizes active or passive radio-frequency identification (RFID). In other embodiments, transceiver 37 may utilize any appropriate technology for transmitting and/or receiving wireless communications, including, but not limited to, infrared (IR), radio remote control (RF Remote Control), and the like.

In certain embodiments, controller 12 includes one or more storage devices 38. While illustrated as being internal to controller 12, storage device 38 may be external to controller 12 and may be communicatively coupled to controller 12 in any appropriate fashion. As an example and not by way of limitation, storage 38 may include an HDD, a floppy disk drive, flash memory, an optical disc, a magneto-optical disc, magnetic tape, or a Universal Serial Bus (USB) drive or a combination of two or more of these. Storage 38 may include removable or non-removable (or fixed) media, where appropriate. In particular embodiments, storage 38 is non-volatile, solid-state memory. In certain embodiments, storage 38 includes random-access memory (RAM) such as battery backed-up RAM. In particular embodiments, storage 38 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates storage 38 taking any suitable physical form. Storage 38 may include one or more storage control units facilitating communication between controller 12 and storage 38, where appropriate. Where appropriate, storage 38 may include one or more storage devices 38. Although this disclosure describes and illustrates particular storage, this disclosure contemplates any suitable storage.

In certain embodiments, one or more profiles 39 may be stored in storage 38. Profiles 39 may be utilized by controller 12 to personalize content displayed on display 36. For example, each profile 39 may be associated with one of a plurality of users who interact with device 20. In certain embodiments, profile 39 may indicate a particular security level of an associated user, and the profile 39 may be utilized to allow access to only certain applications and/or data on device 20 according to the security level of the user. In some embodiments, profile 39 may indicate specific choices for a drop-down menu for a particular user. In certain embodiments, profile 39 may indicate particular preferred visual characteristic for a user, such as particular colors, layouts, backgrounds, fonts, or any other visual characteristic associate with the user. In certain embodiments, controller 12 accesses profiles 39 stored in storage 38 and identifies a particular profile 39 of a particular user using a received identification 48 from stylus 24. In certain embodiments, controller 12 displays content on display 36 according to the particular profile 39 of the particular user.

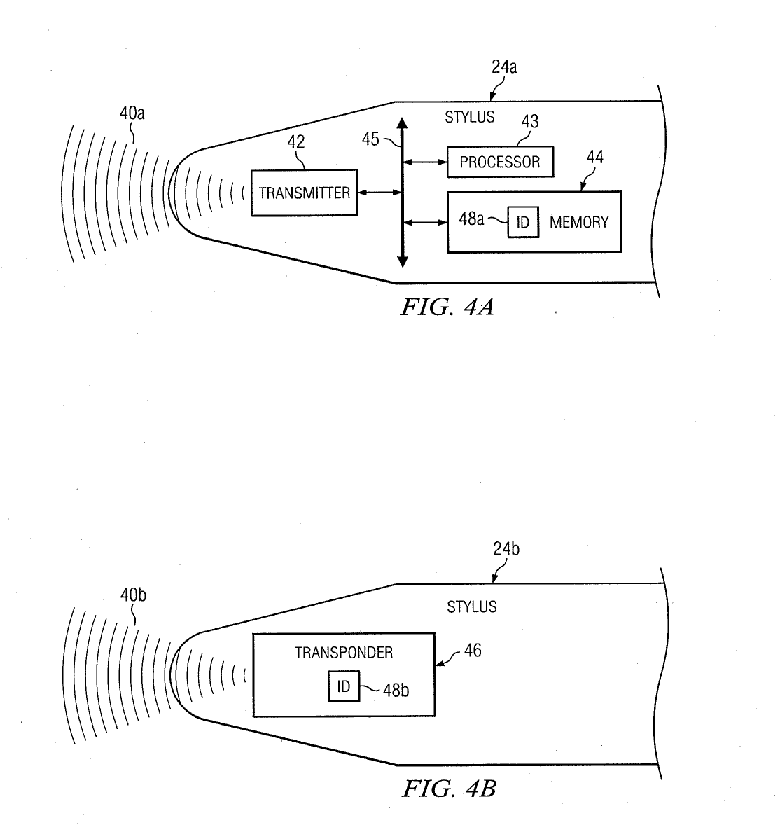

In certain embodiments, stylus 24 may be any form of stylus used for handwriting or drawing on touchscreen display 22. In certain embodiments, stylus 24 may be a typical pencil-shaped stylus as illustrated. In other embodiments, stylus 24 may be a finger stylus (e.g., a stylus that attaches to a user's finger similar to a ring), or any another form of stylus. Certain embodiments of stylus 24 are illustrated below in FIGS. 4A and 4B.

FIGS. 4A and 4B illustrate particular embodiments of stylus 24 that may be utilized to interact with device 20 of FIG. 2. FIG. 4A illustrates an embodiment of a stylus 24a that utilizes any appropriate transmitter 42 to transmit identification 48. For example, transmitter 42 may be an IR transmitter, a radio-frequency transmitter, or any other appropriate transmitter. In certain embodiments, stylus 42a includes a processor 43 and memory 44. Processor 43 may comprise any suitable combination of hardware and software implemented in one or more modules to execute instructions and manipulate data to perform the described functions for stylus 24a. In some embodiments, processor 43 may include, for example, any type of central processing unit (CPU). Processor 43 is generally operable to fetch identification 48a stored in memory 44 and transmit identification 48a via identification signal 40a using transmitter 42. In some embodiments, stylus 24a may include a button that a user may press in order to instruct processor 43 to transmit identification signal 40a using transmitter 42.

Memory 44 includes one or more memory devices for storing identification 48a. As an example and not by way of limitation, memory 44 may include any type of memory disclosed above in reference to storage 38, including RAM. This RAM may be volatile memory, where appropriate. In certain embodiments, memory 44 may be battery backed-up RAM. Where appropriate, memory 44 may be dynamic RAM (DRAM) or static RAM (SRAM). Moreover, where appropriate, this RAM may be single-ported or multi-ported RAM. The present disclosure contemplates any suitable RAM. Memory 44 may include one or more memories 404, where appropriate. One or more buses 45 (which may each include an address bus and a data bus) may couple processor 43, memory 44, and transmitter 42. In particular embodiments, one or more memory management units (MMUs) reside between processor 43 and memory 44 and facilitate accesses to memory 44 requested by processor 43. Although this disclosure describes and illustrates particular memory, this disclosure contemplates any suitable memory.

In certain embodiments, identification 48a may be pre-loaded in memory 44. In other embodiments, a user may interface stylus 24a with another device in order to store identification 48a in memory 44. For example, stylus 24a may include a port for interfacing stylus 24a with another computer system. The other computer system may transmit identification 48a to stylus 24a where it may be stored in memory 44.

FIG. 4B illustrates an embodiment of a stylus 24b that includes a transponder 46 that utilizes passive or active RFID to transmit identification signal 40b that may include identification 48b. For example, transponder 46 may be a passive RFID transponder that receives power from transceiver 37 and transmits identification signal 40b to transceiver 37 when stylus 24b comes within range of transceiver 37. In another example, transponder 46 may be an active RFID transponder that receives power from a power source in stylus 24b (i.e., a battery) and transmits identification signal 40b to transceiver 37 when stylus 24b comes within range of transceiver 37 or is otherwise instructed by a user to transmit identification signal 40b (i.e., by the user pressing a button on stylus 24b).

Returning to FIG. 3, in operation of an example embodiments, controller 12 receives an identification signal 40 transmitted by an object such as stylus 24. In certain embodiments, identification signal 40 is an RFID signal. In other embodiments, identification signal 40 is any appropriate communication such as an IR communication, an RF remote control communication, and the like. Identification signal 40 communicates identification 48 that is stored in stylus 24 (or any another object described herein). Identification 48 may be any appropriate data that may be utilized to personalize content on display 36. In some embodiments, identification 48 may be a unique alpha-numeric string that is associated with a particular user. In certain embodiments, identification 48 may be a password or any other personal data associated with a particular user. As used herein, “identification” such as identification 48 may refer to any appropriate data that is transmitted by an object such as stylus 24 that is used by device 20 to personalize content displayed on display 36.

At any appropriate time after receiving identification 48 from an object such as stylus 24 via identification signal 40, controller 12 accesses profiles 39 that are stored in one or more storage devices 38 accessible to controller 12. As described above, each profile 39 is associated with one of a plurality of users. For example, each profile 39 contains data in the same format as identification 48 that is associated with a particular user. As another example, each profile 39 contains a name of a particular user. Controller 12 identifies, using identification 48 in the received identification signal 40, a particular profile 39. In certain embodiments, controller 12 searches for a particular profile 39 that includes the same identification 48 that is received in identification signal 40. In other embodiments, controller 12 may first search for identification 48 in a database of users in order to locate a name of a particular user associated with identification 48. Controller 12 may then identify a particular profile 39 using the name of the particular user from the database of users.

Controller 12 displays content on display 36 according to the particular profile 39 identified using identification 48. In certain embodiments, the content is displayed on display 36 in response to controller 12 determining that stylus 24 has contacted the transparent panel 34. In other embodiments, the content is displayed on display 36 in response to stylus 24 transmitting identification signal 40. The content displayed on display 36 may be any appropriate data. For example, profile 39 may indicate that a particular user is associated with a particular security level. As a result, only content that is associated with the particular security level may be displayed on display 36 in response to receiving identification 48 associated with the particular user (i.e., the user may only be allowed access to certain applications and/or data on device 20). As another example, profile 39 may indicate specific choices for a particular user. Thus, when identification 48 is received for a particular user, certain choices in an application (i.e., in a drop-down list, etc.) may be presented to the particular user on display 36. In certain embodiments, profile 39 may indicate particular preferred visual characteristic for a user, such as particular colors, layouts, backgrounds, fonts, or any other visual characteristic associate with the user. As a result, visual characteristics displayed on display 36 may be personalized to match those included in profile 39 associated with an identification 48 of a particular user.

In certain embodiments, controller 12 may perform the above operations in response to an object such as stylus 24 contacting transparent panel 34 and/or stylus 24 coming within close enough proximity to device 20 to cause a change in capacitance that is detected by electrodes 32. For example, once stylus 24 touches transparent panel 34 and/or is otherwise detected by controller 12 using electrodes 32, controller 12 may then access profiles 39, identify a particular profile 39 using a received identification signal from stylus 24, and display personalized content on display 36. In other embodiments, controller 12 may perform these operations without first detecting stylus 24 (e.g, without stylus 24 touching transparent panel 34 and/or without otherwise being detected by controller 12). For example, controller 12 may perform these operations at any time after receiving an identification signal transmitted by stylus 24. The disclosure anticipates controller 12 performing the disclosed operations in any appropriate order.

In certain embodiments, a user may utilize a finger to interact with touchscreen display 22 instead of stylus 24. In these embodiments, an object other than stylus 24 stores identification 48 associated with the user that is used by device 20 to personalize content displayed on touchscreen display 22. For example, any appropriate device that comes within close proximity to touchscreen display 22 as the user interacts with touchscreen display 22, such as a ring or watch, may store identification 48. In other embodiments, a device such as a key fob may be utilized to store identification 48 of the user, and the user may place the key fob within close proximity to touchscreen display 22 (or vice versa) in order to transmit identification 48 to device 20.

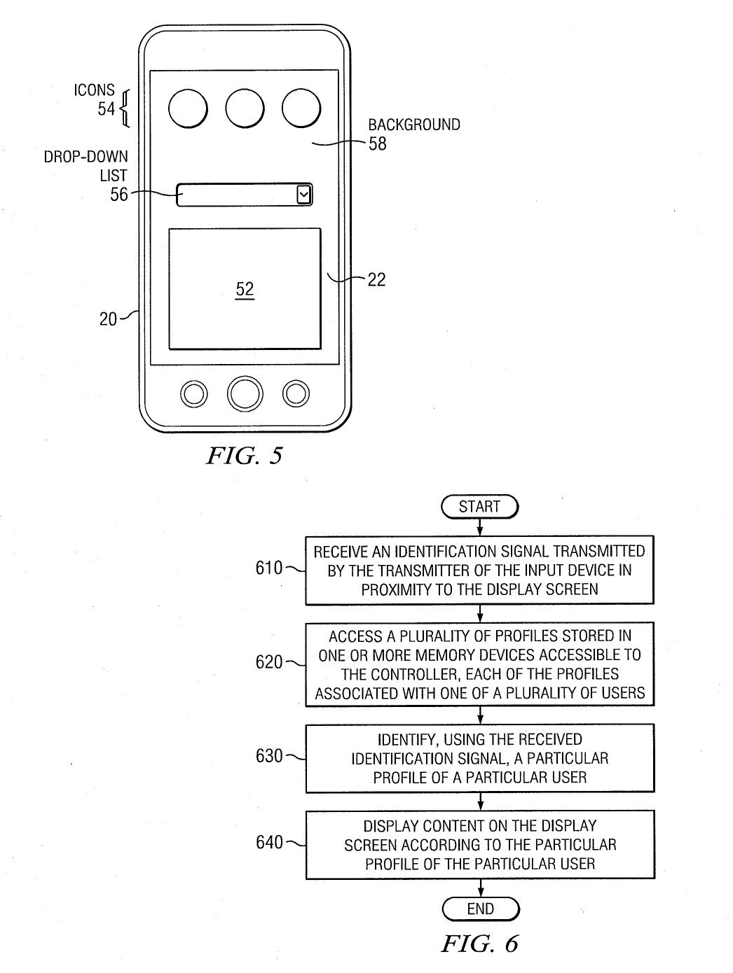

FIG. 5 illustrates personalized content that may be displayed on touchscreen display 22 of device 20 of FIG. 2. In certain embodiments, content that may be displayed on touchscreen display 22 includes a specific application 52, one or more icons 54, a drop-down list 56, and/or visual characteristics such as a background 58. For example, controller 12 may display certain icons 54 according to profile 39 and identification 48 of a particular user. Icons 54 may enable the particular user to utilize certain preferred applications, applications associated with a specific security level of the user, and the like. In another example, controller 12 may display certain content according to profile 39 and identification 48 of a particular user in drop-down list 56. In certain embodiments, controller 12 may personalize the visual appearance of content of display 36 according to profile 39 and identification 48 of a particular user. For example, visual characteristics such as colors, background 58, font sizes and/or colors, etc. may be personalized according to each user's preference as they interact with device 20.

FIG. 6 illustrates a method 600 for displaying content on a display according to an identification of a user stored in stylus 24. In step 610, an identification signal transmitted by an input device is received. In certain embodiments, the identification signal refers to identification signal 40 described above and includes an identification of a user such as identification 48 described above. In certain embodiments, the identification signal is received by a transceiver such as transceiver 37 above and propagated to a controller such as controller 12. In certain embodiments, the identification signal is transmitted by a stylus such as stylus 24a and 24b described above.

In step 620, a plurality of profiles stored in one or more memory devices accessible to the controller are accessed. In certain embodiments, each of the profiles are associated with one of a plurality of users and indicates particular content to display on a display such as display 36 above. In certain embodiments, the plurality of profiles may refer to profiles 39 described above. In certain embodiments, each profile indicates a particular security level of an associated user, specific choices for a drop-down menu for a particular user, and/or particular preferred visual characteristic for a user, such as particular colors, layouts, backgrounds, fonts, or any other visual characteristic associate with the user.

In step 630, a particular profile of a particular user is identified using the received identification signal of step 610. In certain embodiments, a user identification in the received identification signal of step 610 is used to identify the particular profile. In certain embodiments, the user identification may refer to identification 48 described above. In certain embodiments, controller 12 searches for a particular profile 39 that includes the same identification 48 that is received in the identification signal of step 610. In other embodiments, controller 12 may first search for identification 48 in a database of users in order to locate a name of a particular user associated with identification 48. Controller 12 may then identify a particular profile using the name of the particular user from the database of users.

In step 640, content is displayed on the display screen according to the particular profile of the particular user identified in step 630. In certain embodiments, the display screen may refer to display 36 described above. In certain embodiments, the content is displayed on the display screen in response determining that the input device of step 610 has contacted the display screen. In other embodiments, the content is displayed on the display screen in response to the input device of step 610 transmitting the identification signal. The content displayed on the display screen in step 640 may be any appropriate data. For example, content that is associated with a particular security level may be displayed on the display screen in response to receiving an identification signal associated with the particular user (i.e., the user may only be allowed access to certain applications and/or data on the device). As another example, certain choices in an application (i.e., in a drop-down list, etc.) may be presented to the particular user on the display screen. In certain embodiments, certain particular preferred visual characteristic for a user, such as particular colors, layouts, backgrounds, fonts, or any other visual characteristic associate with the user, may be displayed on the display screen. After step 640, method 600 ends.

Although the preceding examples given here generally rely on self capacitance or mutual capacitance to operate, other embodiments of the invention will use other technologies, including other capacitance measures, resistance, or other such sense technologies.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A system comprising:
an input device operable to transmit an identification signal, the identification signal indicative of an identifier stored in the input device;
a display;
a touch sensor overlaying the display;
a transparent panel overlaying the touch sensor; and
a controller communicatively coupled to the display and the touch sensor, the controller operable to:
determine, using the touch sensor, whether the input device has contacted the transparent panel;
receive the identification signal transmitted by the input device;
access a plurality of profiles stored in one or more memory devices accessible to the controller, each of the profiles associated with one of a plurality of users;
identify, using the received identification signal, a particular profile of a particular user; and
display, in response to determining that the input device has contacted the transparent panel, content on the display according to the particular profile of the particular user.

2. The system of claim 1, wherein the input device is a stylus.

3. The system of claim 2, the stylus further comprising:
one or more memory devices operable to store the identifier; and
a transmitter operable to transmit the identification signal indicative of the identifier stored in the one or more memory devices.

4. The system of claim 1, further comprising a transceiver communicatively coupled to the controller, the transceiver operable to:
receive the identification signal transmitted by the input device; and
transmit the identification signal to be received by the controller.

5. The system of claim 4, wherein:
the input device comprises a radio-frequency identification (RFID) transponder; and
the transceiver comprises an RFID transceiver.

6. The system of claim 1, wherein displaying content on the display according to the particular profile of the particular user comprises displaying data according to a security level indicated in the particular profile.

7. The system of claim 1, wherein displaying content on the display according to the particular profile of the particular user comprises displaying visual characteristics indicated in the particular profile.

8. An interactive display comprising:
a display;
a touch sensor overlaying the display screen;
a transceiver operable to receive an identification signal transmitted by an input device, the identification signal indicative of an identifier stored in the input device; and
a controller communicatively coupled to the display screen, the transceiver, and the touch sensor, the controller configured to:
detect, using the touch sensor, whether a user is using the input device to interact with the interactive display;
receive, from the transceiver, the identification signal transmitted by the input device;
access a plurality of profiles stored in one or more memory devices accessible to the controller, each of the profiles associated with one of a plurality of users;
identify, using the received identification signal, a particular profile of a particular user; and
display, in response to determining that the user is interacting with the interactive display, content on the display screen according to the particular profile of the particular user.

9. The interactive display of claim 8, wherein the input device comprises a stylus.

10. The interactive display of claim 8, wherein detecting whether the user is using the input device to interact with the interactive display comprises determining whether the input device has contacted the interactive display.

11. The interactive display of claim 8, wherein detecting whether the user is using the input device to interact with the interactive display comprises determining whether the input device has caused a change in capacitance across one or more electrodes of the touch sensor without contacting the interactive display.

12. The interactive display of claim 8, wherein displaying content on the display according to the particular profile of the particular user comprises displaying data according to a security level indicated in the particular profile.

13. The interactive display of claim 8, wherein displaying content on the display according to the particular profile of the particular user comprises displaying visual characteristics indicated in the particular profile.

14. The interactive display of claim 8, wherein the transceiver comprises a radio-frequency identification (RFID) transceiver.

15. A method comprising:
determining, by a touch sensor coupled to a display, whether a particular user is using an input device to interact with the interactive display;
receiving, at a controller, an identification signal transmitted by the input device, the identification signal indicative of an identifier stored in the input device;
accessing, by the controller, a plurality of profiles stored in one or more memory devices accessible to the controller, each of the profiles associated with one of a plurality of users;
identifying, by the controller using the received identification signal, a particular profile of the particular user; and
displaying, by the controller in response to the touch sensor determining that the user is using the input device to interact with the interactive display, content on the display according to the particular profile of the particular user.

16. The method of claim 15, wherein the input device comprises a stylus.

17. The method of claim 15, wherein determining whether the particular user is using the input device to interact with the interactive display comprises determining whether the input device has contacted the interactive display.

18. The method of claim 15, wherein determining whether the particular user is using the input device to interact with the interactive display comprises determining whether the input device has caused a change in capacitance across one or more electrodes of the touch sensor without contacting the interactive display.

19. The method of claim 15, wherein displaying content on the display according to the particular profile of the particular user comprises displaying data according to a security level indicated in the particular profile.

20. The method of claim 15, wherein displaying content on the display according to the particular profile of the particular user comprises displaying visual characteristics indicated in the particular profile.
